(19) United States
(12) Patent Application Publication
(10) Pub. No.: US 2020/0340636 A1
(43) Pub. Date: Oct. 29, 2020

(54) INDUCTIVE POWER SOLAR LIGHT WITH MICROWAVE MOTION SENSOR

(71) Applicant: IDEAPOND LLC, San Diego, CA (US)

(72) Inventor: Dennis Bertken, San Diego, CA (US)

(73) Assignee: IDEAPOND LLC, San Diego, CA (US)

(21) Appl. No.: 16/955,822

(22) PCT Filed: Dec. 22, 2018
(86) PCT No.: PCT/US2018/067411

§ 371 Date: Jun. 19, 2020

Related U.S. Application Data
(60) Provisional application No. 62/610,061, filed on Dec. 22, 2017.

(51) Int. Cl. F21S 9/03; F21V 21/096; F21V 23/04; F21V 33/00; F21K 9/20

(52) U.S. Cl. CPC F21S 9/032; F21V 21/096; F21W 2131/10; F21V 33/006; F21K 9/20; F21V 23/0471

(57) ABSTRACT

The light fixture has two separate and distinct portions, i.e., a lower portion and an upper portion, that are magnetically connected to one another. The lower portion contains a light source; a rechargeable battery; provision for an auxiliary power source; and an inductive power receiving loop. Further, depending on the objectives of the user, the lower portion may also contain a USB port, a motion sensor and/or a momentary push-button switch. The upper portion contains a solar panel and an inductive power transmitting loop. The rechargeable battery is charged inductively through electromagnetic induction, using electricity generated by the one or more solar panels. The rechargeable battery can also be charged using the USB port. The magnetic connection between the upper and lower portions allows them to join to one another through thin material, such as an umbrella canopy, tent wall, or awning, without damaging the material.

### CROSS-REFERENCE TO RELATED APPLICATION(S)

The present application claims priority to U.S. Provisional Patent Application No. 62/610,061 filed on Dec. 22, 2017, entitled “INDUCTIVE POWER SOLAR LIGHT WITH MICROWAVE MOTION SENSOR”, the entire disclosure of which is incorporated by reference herein.

### FIELD OF THE INVENTION

The disclosure relates generally to the field of outdoor wireless solar lights.

### BACKGROUND OF THE INVENTION

Outdoor umbrellas have been used in residential and commercial settings for many years. Traditionally, they serve the purpose of creating comfortable shade in an otherwise sunny, hot environment. However, in recent times, it has become popular to use outdoor umbrellas during evening activities such as outdoor dinners or other evening events. It is desirable to have a source of illumination during such evening events.

Similarly, camping tents have been used for many years by consumers and they serve the purpose of creating a comfortable short-term living arrangement for occupants during their outdoor adventure outings. However, in recent times, it has become popular to purchase camping accessories that are not reliant on disposable batteries or conventional power outlets, but rather solar-powered camping accessories which can store up power for usage during the evening hours, when light is scarce.

To this end, the addition of a lighting fixture to the underside of an umbrella, tent, or any outdoor fixture or covering, which could shine light down on a table and surrounding people or other objects would be desirable. Also desirable is a lighting source that, by using solar power and/or batteries as a power source, can operate wirelessly, i.e., without being plugged into an electrical outlet. And yet further desirable is a lighting fixture that uses the sun as a means of recharging its battery power source.

### BRIEF SUMMARY OF THE INVENTION

In an embodiment, a solar light generates electrical power using solar panels, whereby the electrical power is used to recharge an integrated rechargeable battery. Further, one or more auxiliary power source(s) are used to power the solar light as the rechargeable battery is depleted.

In an embodiment, the housing for the solar light includes two mating portions, i.e., a lower portion and an upper portion, that are magnetically connected to one another. The magnetic connection allows the housing to be maintained securely into position on opposing surfaces of thin materials, such as fabric, wood products, glass, etc., and obviates the need for more permanent attachment means, e.g., screws, bolts, nails, etc., for securing the solar light into position.

In an embodiment, the solar light includes microwave motion sensor(s) for sensing motion of nearby objects, whereby light output from the light is adjusted, based on movement sensed in close proximity to the solar light.

In an embodiment, the solar light uses inductive charging technology to recharge an integrated rechargeable battery, whereby power is wirelessly transmitted from the upper portion of the housing to the lower portion of the housing.

In an embodiment, the solar light includes a microwave sensor that is controlled by the microcontroller to reduce power consumption by time slicing the microwave sensing input to achieve reduced power usage as compared to traditional microwave sensors integrated into outdoor solar lights.

In an embodiment, the solar light provides intelligent light illumination, whereby, if the microcontroller determines that the ambient light sensor is receiving a predetermined amount of light, the light is powered off. Alternatively, if the microcontroller determines that the ambient light sensor is not receiving a predetermined amount of light, the light is powered on.

In an embodiment, the solar light uses a microwave sensor for intelligent motion sensing, whereby the light is initially set to ‘DIM’ mode, but, as moving objects are sensed by the microwave sensor, an alternative mode, e.g., ‘MODERATE’ mode or ‘BRIGHT’ mode, is initiated.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows the solar light with the upper and lower portions joined together, according to an embodiment of the present invention;

FIG. 2 shows the solar light with the upper and lower portions separated, according to an embodiment of the present invention;

FIG. 3 shows the solar light with the upper and lower portions separated, according to an embodiment of the present invention;

FIG. 4 shows the solar light with the upper and lower portions separated, according to an embodiment of the present invention;

FIG. 5 shows the solar light's auxiliary battery compartment, according to an embodiment of the present invention;

FIG. 6 shows the solar light mounted on an umbrella canopy, according to an embodiment of the present invention;

FIG. 7 shows the solar light mounted on an umbrella canopy, according to an embodiment of the present invention;

FIG. 8 shows the upper portion of the solar light in a disassembled state, according to an embodiment of the present invention;

FIG. 9 shows the lower portion of the solar light in a disassembled state, according to an embodiment of the present invention;

FIG. 10 shows a flow diagram of the solar light operation, according to an embodiment of the present invention;

FIG. 11 shows a flow diagram of the solar light operation, according to an embodiment of the present invention;

FIG. 12 shows a flow diagram of the solar light operation, according to an embodiment of the present invention;

FIG. 13 shows a flow diagram of the solar light operation, according to an embodiment of the present invention;

FIG. 14 shows a flow diagram of the solar light operation, according to an embodiment of the present invention;

FIG. 15 shows a flow diagram of the solar light operation, according to an embodiment of the present invention;

FIG. 16 shows a flow diagram of the solar light operation, according to an embodiment of the present invention;

FIG. 17 shows a flow diagram of the solar light operation, according to an embodiment of the present invention;

FIG. 18 shows a flow diagram of the solar light operation, according to an embodiment of the present invention; and

FIG. 19 shows a flow diagram of the solar light operation, according to an embodiment of the present invention.

### DETAILED DESCRIPTION OF THE INVENTION

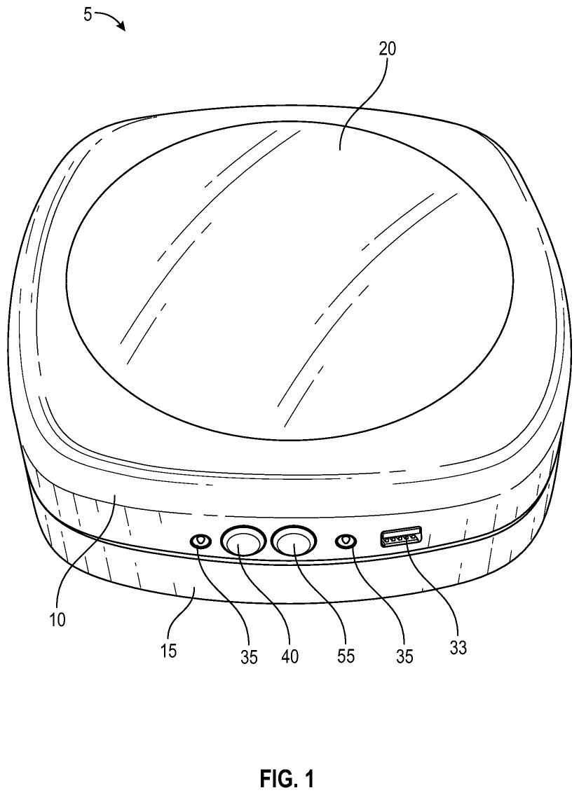

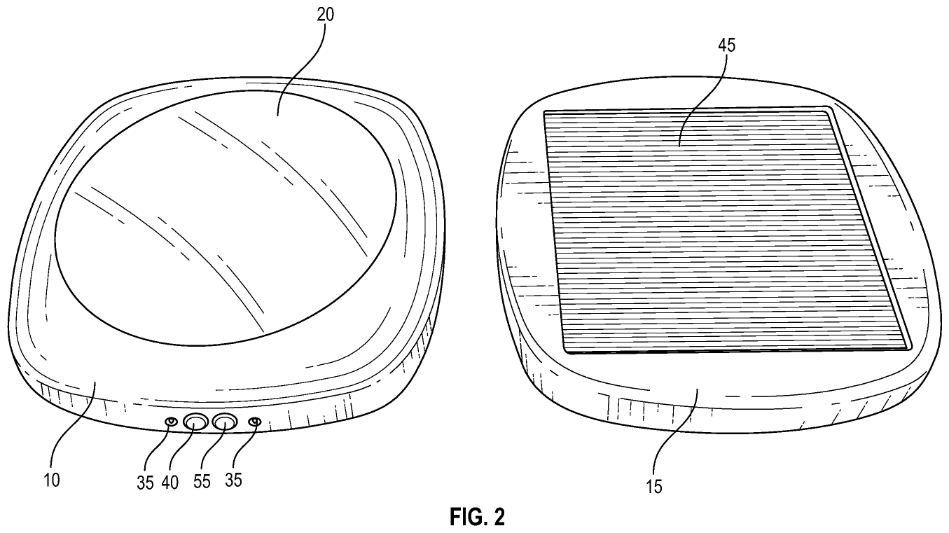

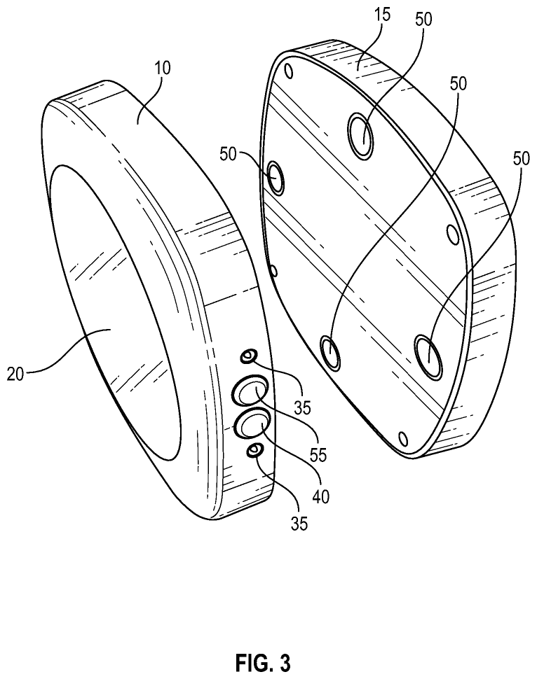

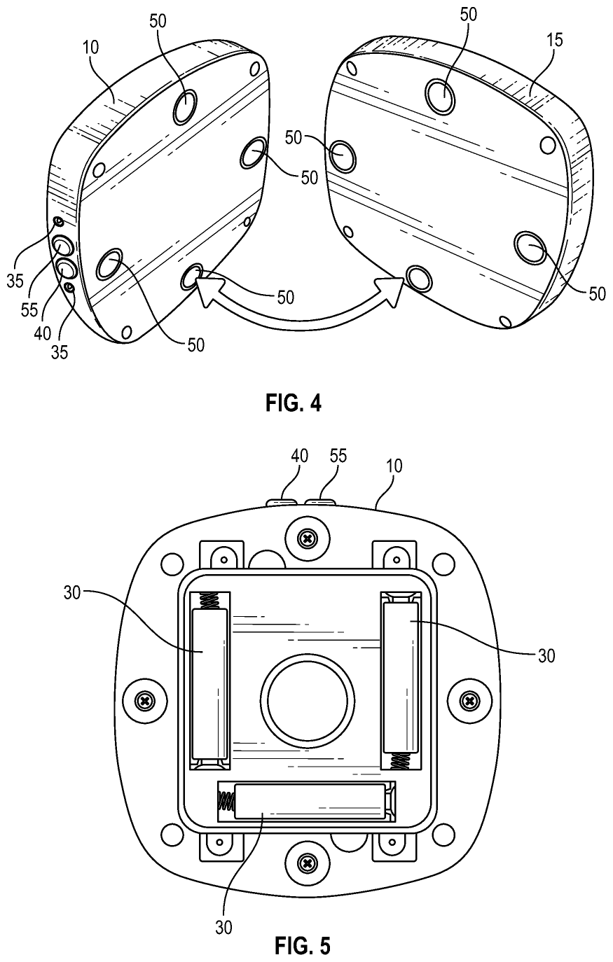

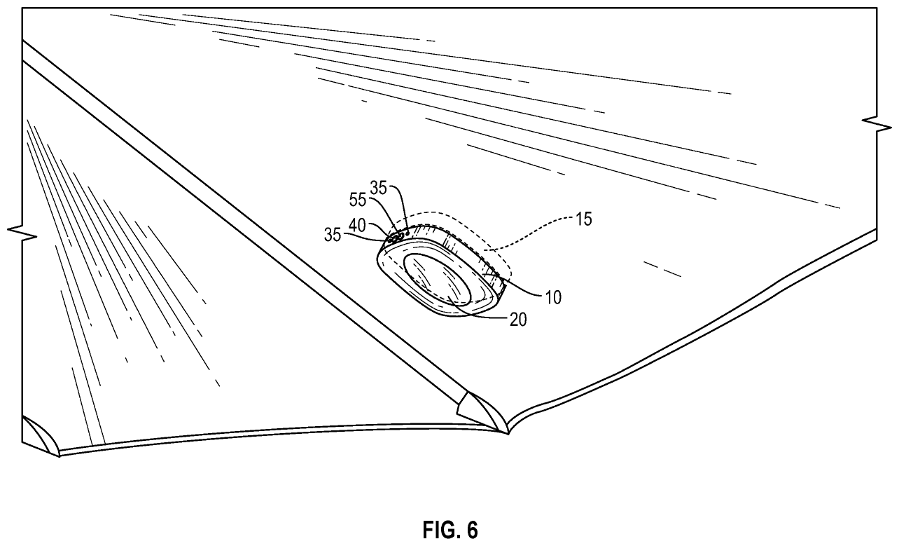

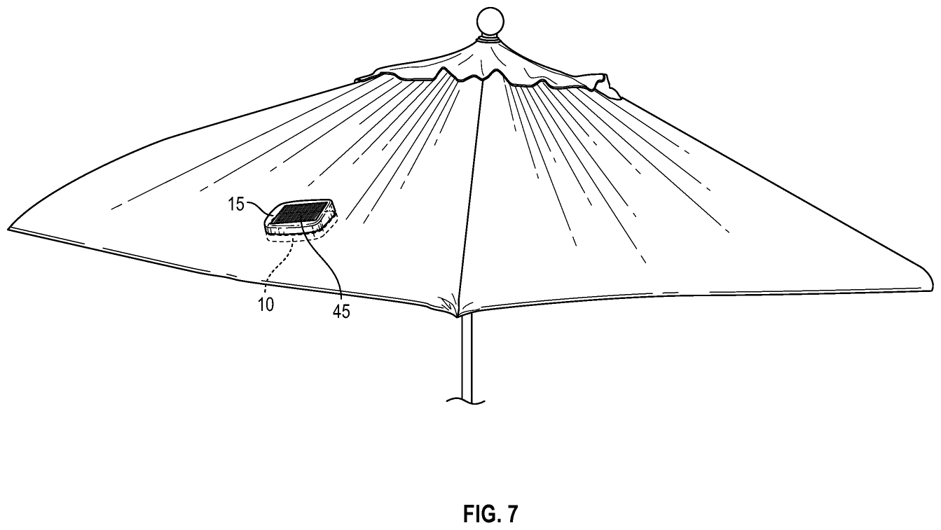

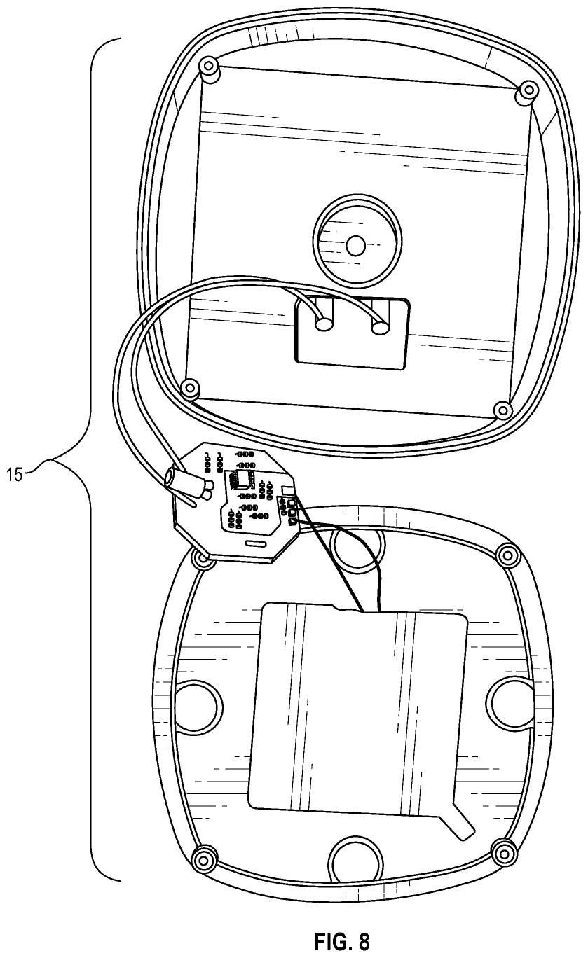

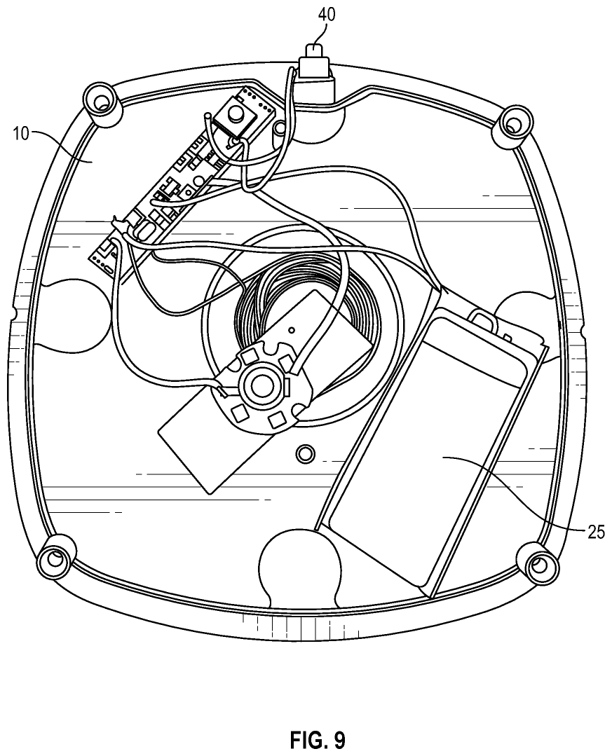

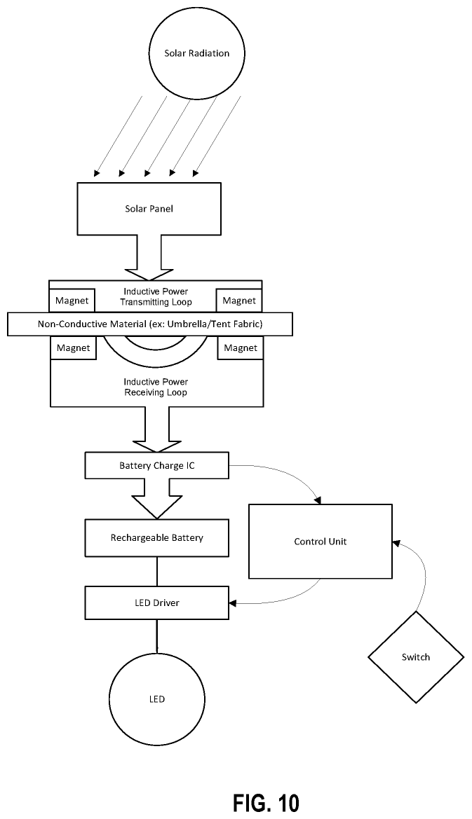

With reference to FIGS. 1-9, the solar light 5 includes two separate and distinct portions, i.e., a lower portion 10 and an upper portion 15. The upper portion 15 contains one or more solar panels 45 and an inductive power transmitting loop. In an embodiment, the inductive power transmitting loop includes a first induction coil. Electrical current generated by the solar panel(s) 45 is passed through the first induction coil to create an alternating electromagnetic field, i.e., an inductive field, that wirelessly transmits power to the lower portion 10.

The lower portion 10 contains a light source 20, e.g., an LED light; rechargeable battery(ies) 25; provision for an auxiliary power source 30, e.g., two (2) AA or three (3) AAA alkaline batteries; a USB port 33; one or more motion sensor(s) 35; a momentary push-button switch 40; a power button 55; and an inductive power receiving loop. In an embodiment, the inductive power receiving loop includes a second induction coil coupled to or incorporated into the rechargeable battery(ies) 25, whereby the second induction coil receives, or intercepts, power from the electromagnetic field generated by the first induction coil and converts it back into electrical current to charge the rechargeable battery(ies) 25.

In a preferred embodiment, the upper and lower portions 10, 15 include magnets 50 to releasably join the portions 10, 15 to one another. This provides a number of unique benefits. First of all, the magnetic joinder of the portions 10, 15 allows the solar light 5 to be releasably connected to a thin material, e.g., a tent wall, awning, or umbrella canopy, whereby the upper portion 15 is attached to an exterior, i.e., outside- or upperside-facing, surface of the material and the lower portion 10 is attached to an interior, i.e., inside- or underside-facing, surface of the material. The magnetic attachment (vs. a more permanent or invasive means of affixation, e.g., nails, screws, bolts, etc.) of the solar light 5 to the material allows a user to easily adjust the position of the solar light 5, e.g., by sliding the solar light 5 along the material, obviating the need for removal of the solar light 5 from the material. Additionally, if so desired, a user can disconnect the portions 10, 15 from one another, whereby the lower portion 10 can be magnetically connected to any ferromagnetic object and used as a standalone lighting source, i.e., independent from the upper portion 15.

### Unit Operation

The solar light is intended to be removably joined to a covering, e.g., an outdoor umbrella or tent, whereby the upper portion containing the solar panel is positioned on the outside of the covering and the lower portion containing the light source is positioned on the inside of the covering. During the day the inductive loop charges the embedded rechargeable battery. When the sun goes down and ambient light drops below useful power output, the light source turns on at the lowest power/lighting setting, e.g., 3-5 lumens. When motion is detected, the brightness increases to a mid-power/lighting setting, e.g., 25-50 lumens.

When the internal rechargeable battery is depleted, e.g., when the voltage drops to 3.0 v, the solar light switches its power source to the auxiliary power source, e.g., alkaline battery(ies), to maintain light output at the current level. If no auxiliary power source is installed, the light will shut off, fading out over 30 seconds, whereby the MCU will go to sleep to mitigate further power drain on the internal battery to prevent discharging of the rechargeable battery below 2.8 v.

Once the rechargeable battery is depleted and the solar light switches its power source to the auxiliary power source, the light only powers on when the ambient light sensor detects darkness and the microwave motion sensor detects movement. Under this condition, there is no 3-5 lumen option, only motion-activated lighting.

Following are exemplary specifications for the solar light, and are in no way intended to limit the scope of the invention.

### Specification

### Physical:

Shape: round or square with rounded corners.

Size: 80-110 mm Diameter or side length. Minimum necessary height to enclose components.

Water Resistance: IPX4 minimum rating, IPX5, IPX7 desired.

### Electrical:

Solar panel: square (80×80 mm), round(110 mm) 5 v, 100-300 ma @ 1,000/m².

Rechargeable Battery: 500-1,000 mAh Li-Ion battery. Battery size based on a solar panel that will fit housing.

Light source: ability to produce multiple outputs, e.g., 5, 30 and 60 lumen outputs.

Replaceable Battery: two (2) AA or three (3) AAA battery holder within the lower portion.

Momentary push-button switch: mounted on side of the lower, i.e., lighting, section to toggle between off, mid and max light output. While the switch is described herein as a push-button, the invention should not be regarded as being limited in scope to any particular type of switch.

Inductive power loop: to transfer power from solar panel to rechargeable battery.

### Design

Lens: translucent lens to diffuse light source.

Light source position: light source, e.g., LED, set back far enough from lens or other diffusing method used to provide even, diffused light, across lens surface.

Motion Sensor: minimal exposure of PIR element, flat lens. Use of microwave sensor running at 1-5% duty cycle is preferred.

### Recommended/Preferred Components:

LED: mid-power lumen, low power draws LED. (30 lm, 65 ma, 2.8 v)

Solar Panel: 80 mm×80 mm×3 mm 5 v, 0.9 w epoxy+monocrystalline+PCB

The solar light disables the LED and motion detector when sufficient light is detected, e.g., during the day. The solar light charges the internal battery until it is no longer able to obtain sufficient useful light to continue charging. It then changes to a lighting mode based on the switch position.

FIG. 10 (Simple Solar Light—Charge Cycle)—When the solar light is positioned so that the solar panel is receiving light, the solar light will charge the battery. Solar light is converted to electricity by the solar panel and then to an inductive power transmitting loop via an oscillating circuit. The oscillation in the circuit creates a magnetic field around the inductive power transmitting loop that is continually expanding and collapsing. As the magnetic field expands and collapses it cuts across the conductors in the inductive power receiving loop. This generates electrical power on the lower, i.e., lighting, portion of the solar light which is run through a battery charge circuit to recharge the internal battery.

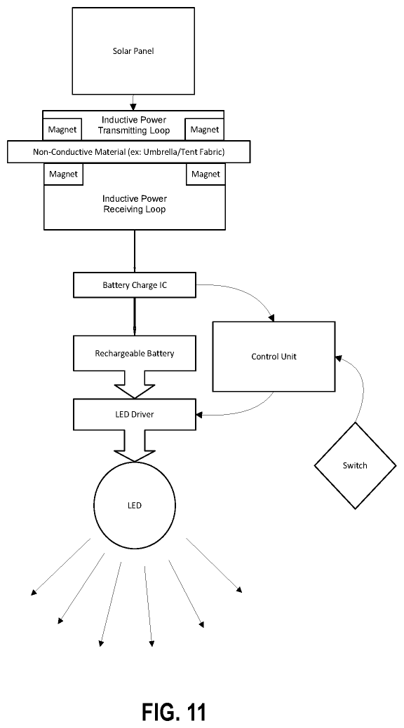

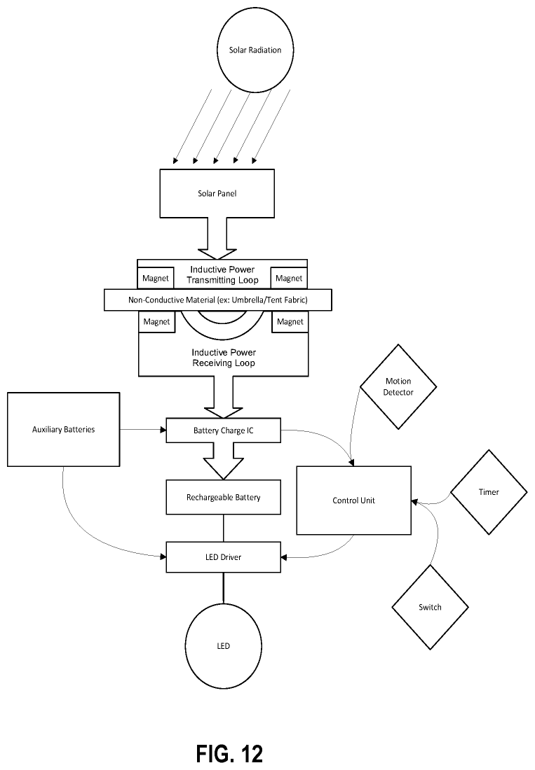

FIG. 11 (Simple Solar Light—Lighting Cycle)—When solar or other irradiation of the solar panel drops to the point that usable power is no longer generated by the solar panel, the solar light will switch to lighting mode.

In lighting mode the inductive power loop is quiescent, and the lighting component is active.

The power stored throughout the day in the rechargeable battery is utilized to power the light source/LED for as long as possible. In an embodiment, a switch is incorporated that toggles the light output of the LED through various settings to increase or decrease brightness.

When an external user uses the switch, the switch sends a signal to the control unit (MCU/Processor), wherein the control unit sends a subsequent signal to the battery charge internal circuit and the LED driver. The LED driver receives power from the rechargeable battery.

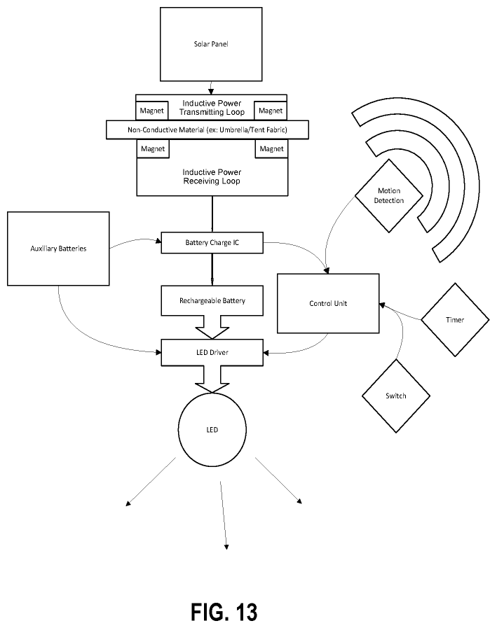

FIG. 12 (Solar Light—Charge Cycle)—When the solar light is positioned so that the solar panel is receiving light, the solar light will charge the battery. Solar light is converted to electricity by the solar panel and then to an inductive power transmitting loop via an oscillating circuit. The oscillation in the circuit creates a magnetic field around the inductive power transmitting loop that is continually expanding and collapsing. As the magnetic field expands and collapses it cuts across the conductors in the inductive power receiving loop. This generates electrical power on the lower, i.e., lighting, portion of the solar light which is run through a battery charge circuit to recharge the internal battery.

Lighting components are in low power quiescent mode during charge cycle.

FIG. 12 illustrates the integration of a motion detector and timer, wherein the light intensity might be adjusted due to sensing of motion in close proximity to the solar device. Additionally, the timer will be utilized to determine if the motion detector senses any additional movement after a specified time period has elapsed. In such an embodiment, the timer serves as a count-down timer.

FIG. 13 (Solar Light—Low Light Cycle)—When solar or other irradiation of the solar panel drops to the point that usable power is no longer generated by the solar panel, the solar light will switch to lighting mode.

In this mode the inductive power loop is quiescent, and the lighting component is active.

The power stored throughout the day in the rechargeable battery is utilized to power a LED for as long as possible.

Light will be turned on at low power/lighting setting, e.g., 5 lumens, to provide low glow to surrounding area. The motion detector will be active at low duty cycle to minimize impact on the internal battery.

The auxiliary batteries are removable and replaceable batteries, e.g., AA, AAA, 9-volt batteries, that provide an auxiliary power source to the LED driver to power the LED's to produce light.

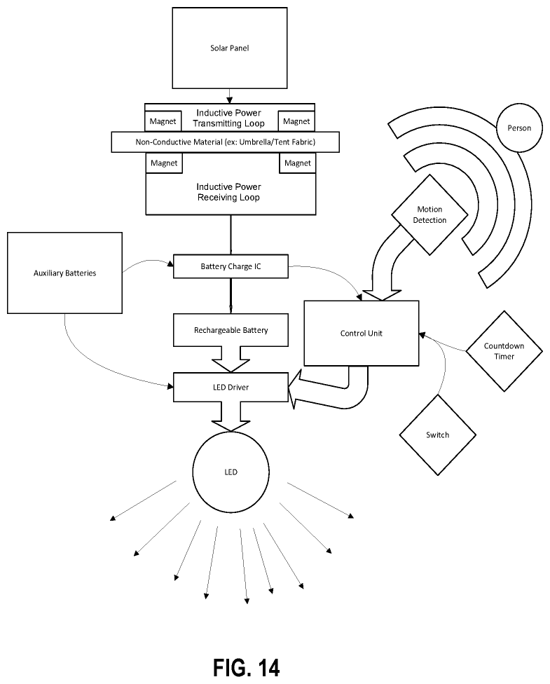

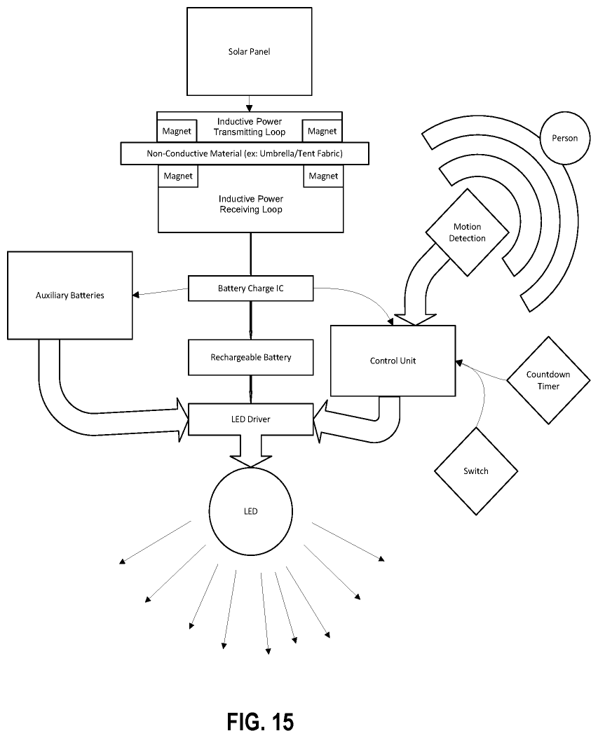

FIG. 14 (Solar light—Motion detected)—When a person or object triggers the motion detector, the control unit will start a countdown timer and trigger the light source to increase brightness.

Each new detection will reset the countdown timer. Once it counts down to “0” the control unit will return the light output to the lowest state.

If the switch is pressed, the light will change to a new state. i.e. medium brightness to high brightness.

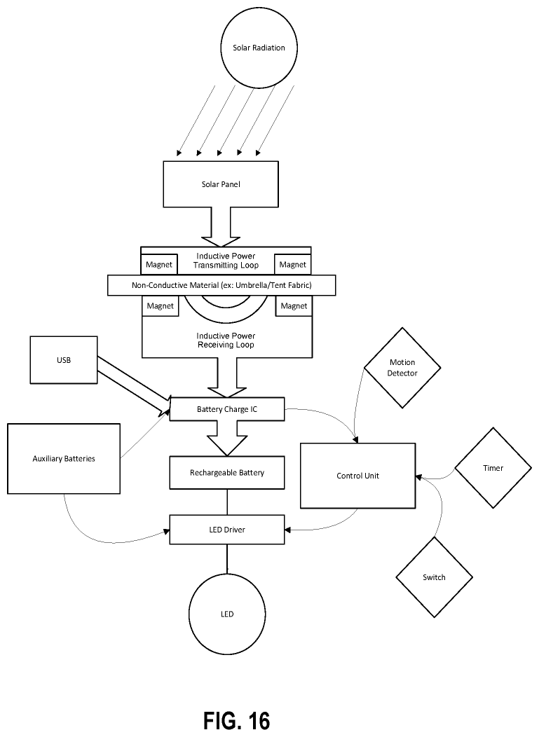

FIG. 15 (Solar Light—Auxiliary Batteries)—In an embodiment, the solar light includes an auxiliary power source, e.g., alkaline batteries, NiMH batteries, etc. When the internal rechargeable battery is consumed, the battery charge IC will notify the control unit of the state of the internal battery. The control unit will determine if auxiliary batteries are installed. If auxiliary batteries are installed the light source (LED in the diagram) will switch to drawing power from the auxiliary batteries. In this way, operation of the solar light can be extended.

FIG. 16 (Solar Light—USB Charging)—In an embodiment, one or more USB ports are integrated into the lower, i.e., lighting, portion of the device. The USB-In can be used to re-charge the internal rechargeable battery in addition to, or in lieu of, using the solar panel.

With the USB charging capability, the solar light may be charged while traveling or at any other time that exposure to the sun is impractical or unavailable for recharging the battery.

Due to the power source(s), e.g., rechargeable battery(ies), auxiliary battery(ies), USB-connected power source, independently available to the lower, i.e., LED/light, portion, the lower portion may the used independent of the upper, i.e., solar panel, portion. When used independent of the upper portion, the magnets on the rear surface of the lower portion allow it to be attached to any ferromagnetic surface.

Moreover, the solar light may integrate a USB-Out to allow the solar light to charge a cell phone or any external device needing an electric charge.

### Exterior Construction

The solar light outer structure may be comprised of rubberized material construction.

### Slide Switch

Off—battery disconnected.

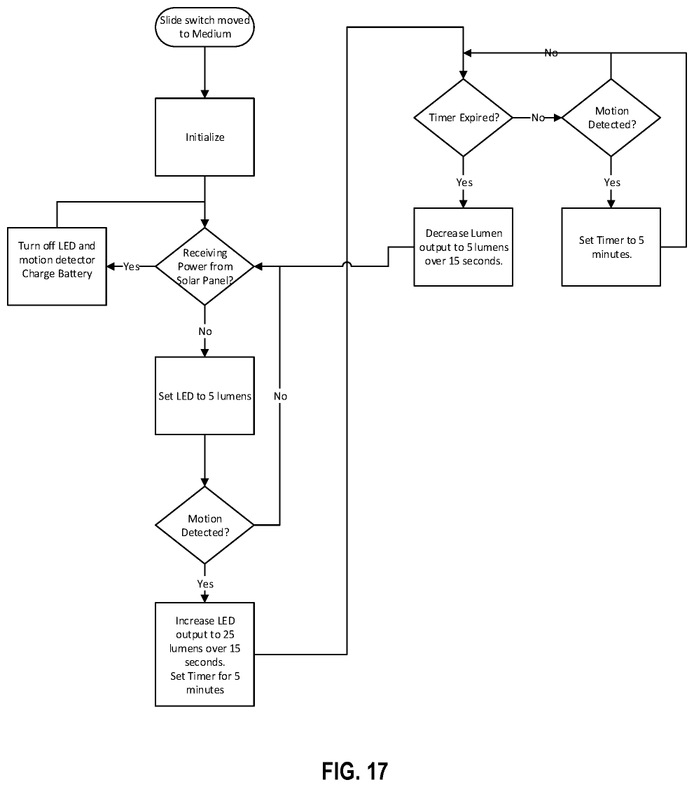

Medium (FIG. 17)—When insufficient light exists to charge the battery, turn on the LED at approximately 5 lumens and turn on the motion detector. When motion is detected, increase LED brightness to approximately 30 lumens over 15 seconds, i.e., gradual smooth increase to 30 lumens. Set timer for 5 minutes. If motion is detected before the timer expires, reset the timer to 5 minutes. If the timer expires, fade LED brightness to 5 lumens over 15 seconds, i.e., gradual smooth decrease to 5 lumens).

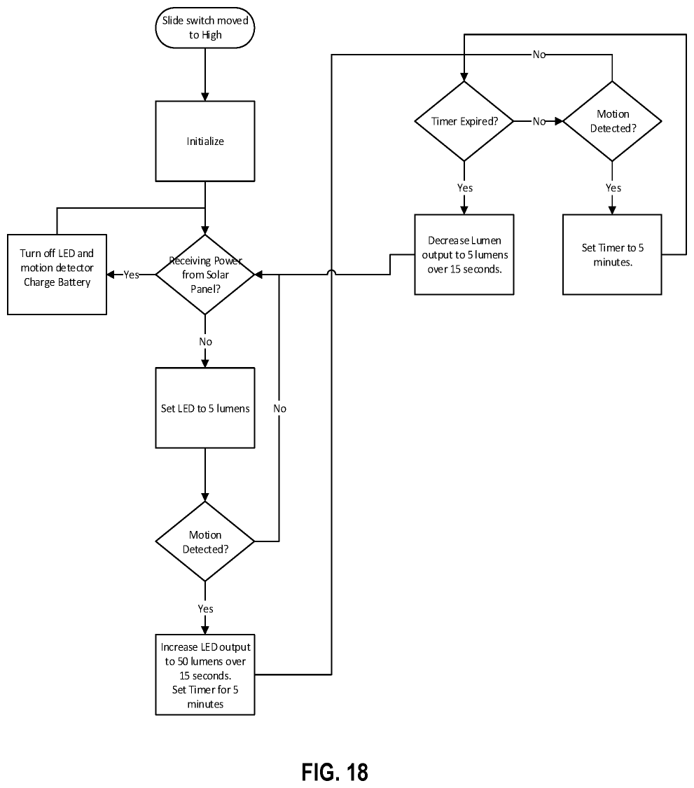

High (FIG. 18)—When insufficient light exists to charge the battery, turn on the LED at approximately 5 lumens and turn on the motion detector. When motion is detected, increase LED brightness to approximately 50 lumens over 15 seconds, i.e., gradual smooth increase to 50 lumens. Set the timer for 5 minutes, if motion is detected before the timer expires, reset the timer to 5 minutes. If the timer expires, fade LED brightness to 5 lumens over 15 seconds, i.e., gradual smooth decrease to 5 lumens.

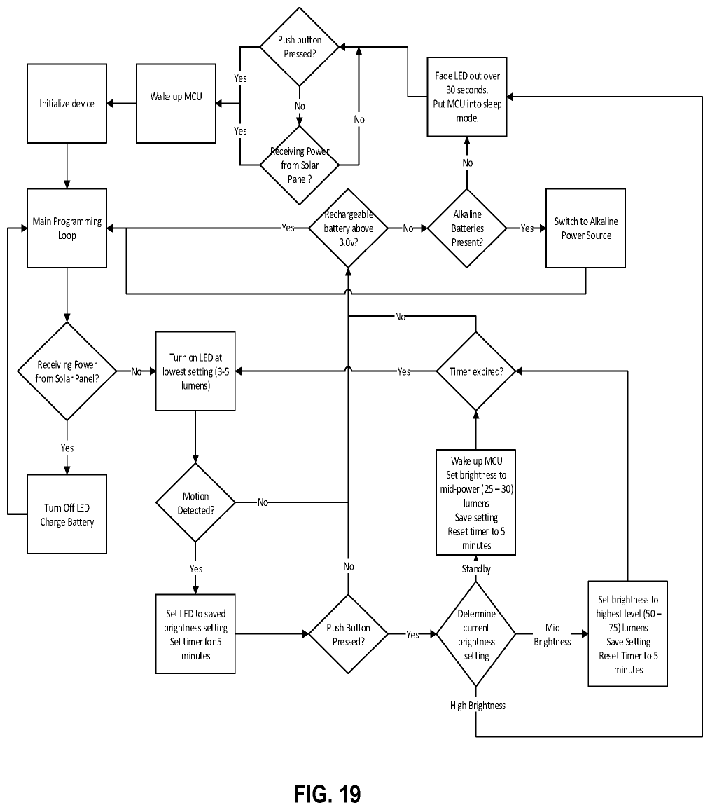

Momentary Switch (FIG. 19)

Battery Protection—The solar light should monitor battery charge state and shut down gracefully or switch to the auxiliary power source when the internal Li-Ion battery is discharged.

When the solar light is shut down due to battery discharge, all power is removed from the LED and motion detector, and the MCU is put into sleep state. Inductive power activity brings the MCU out of sleep and initiates the battery charging cycle. Care should be taken to make sure the Li-Ion battery is not under- or over-charged.

### Time Slicing Microwave Sensor

The period of time for which a process is allowed to run in a preemptive multitasking system is generally called the time slice or quantum. The scheduler is run once every time slice to choose the next process to run. The length of each time slice can be critical to balancing system performance vs. process responsiveness. If the time slice is too short, the scheduler will consume too much processing time. Alternatively, if the time slice is too long, processes will take longer to respond to input.

An interrupt is scheduled to allow the operating system kernel to switch between processes when their time slices expire, effectively allowing the processor's time to be shared between a number of tasks, giving the illusion that it is dealing with these tasks in parallel, i.e., simultaneously. The operating system that controls such a design is called a multi-tasking system.

In simple terms: Preemptive multitasking involves the use of an interrupt mechanism which suspends the currently executing process and invokes a scheduler to determine which process should execute next. Therefore, all processes will get some amount of CPU time at any given time.

In preemptive multitasking, the operating system kernel can also initiate a context switch to satisfy the scheduling policy's priority constraint, thus preempting the active task. In general, preemption means “prior seizure of”. When the high priority task at that instance seizes the currently running task, it is known as preemptive scheduling.

The term “preemptive multitasking” is sometimes mistakenly used when the intended meaning is more specific, referring instead to the class of scheduling policies known as time-shared scheduling, or time-sharing.

### Induction Thru Glass

In one embodiment of the new design, the induction may be carried out through strong magnets that allow a layer of glass to come between the two separate pieces, i.e., upper and lower portions, of the solar light. The magnet may require higher surface area coverage in order to allow for induction through glass. The surface area for the induction loop may also be greater for embodiments that require induction through glass.

### Motion Sensor

The ability of an on-board motion sensor integrated into the control module, i.e., the CPU or microprocessor, to transmit a signal to other external devices to allow them to turn on based on motion sensor activation of the on-board motion sensor.

### Sound Frequency Sensor

The ability of the on-board sound frequency sensor for sensing sound frequencies which may be attributable from smoke alarms or carbon monoxide alarms within a defined range. So, in example, a nearby alarm, i.e. sound alarm, is triggered which is detected by the sound detector/sensor, which in turn is triggered on and in communication with the CPU/microprocessor, and the CPU/microprocessor may optionally transmit an external signal to external components to turn on or react in a certain manner, in view of the sound detected.

### WIFI Module

A built in WiFi module connected to the CPU/microprocessor to allow the solar light to connect with WiFi enabled technologies to allow connectivity with cloud applications to further allow remote control of the solar light and remote notifications.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A light fixture comprising:
a. an upper portion comprising:
i. one or more solar panels;
ii. an inductive power transmitting loop in electrical communication with the one or more solar panels; and
iii. one or more magnets; and
b. a lower portion comprising:
i. a light source;
ii. an inductive power receiving loop in electromagnetic communication with the inductive power transmitting loop;
iii. one or more rechargeable batteries in electrical communication with the light source and the inductive power receiving loop; and
iv. one or more magnets,
wherein the upper portion is magnetically connected to the lower portion, and wherein the one or more rechargeable batteries are inductively charged, through electromagnetic induction, using electricity generated by the one or more solar panels.

2. The light fixture of claim 1, wherein the one or more solar panels are disposed at a top surface of the upper portion and the upper potion's one or more magnets are disposed at a bottom surface thereof, and wherein the light source is disposed at a bottom surface of the lower portion and the lower portion's one or more magnets are disposed at a top surface thereof.

3. The light fixture of claim 1, wherein the lower portion further comprises an auxiliary power source in electrical communication with the light source.

4. The light fixture of claim 3, wherein the auxiliary power source is one or more batteries.

5. The light fixture of claim 1, wherein the lower portion further comprises a USB port in electrical communication with the one or more rechargeable batteries.

6. The light fixture of claim 1, wherein the lower portion further comprises a motion sensor in electrical communication with the light source and the one or more rechargeable batteries.

7. The light fixture of claim 1, wherein the lower portion further comprises a switch for adjusting the intensity of the light source, the switch being in electrical communication with the light source and the one or more rechargeable batteries.

8. The light fixture of claim 1, wherein the light source includes LED lights.

9. The light fixture of claim 1, wherein the lower portion further comprises:
a. an auxiliary power source in electrical communication with the light source;
b. a USB port in electrical communication with the one or more rechargeable batteries;
c. a motion sensor; and
d. a switch for adjusting the intensity of the light source, the switch and the motion sensor being in electrical communication with the light source and the one or more rechargeable batteries.

10. A light fixture comprising:
a. an upper portion comprising:
i. one or more solar panels; and
ii. a first induction coil in electrical communication with the one or more solar panels; and
b. a lower portion comprising:
i. a light source;
ii. a second induction coil in electromagnetic communication with the first induction coil; and
iii. one or more rechargeable batteries in electrical communication with the light source and the second induction coil,
wherein the upper portion is magnetically connected to the lower portion, and
wherein the one or more rechargeable batteries are inductively charged, through electromagnetic induction, using electricity generated by the one or more solar panels.

11. The light fixture of claim 10, wherein the one or more solar panels are disposed at a top surface of the upper portion, and wherein the light source is disposed at a bottom surface of the lower portion.

12. The light fixture of claim 10, wherein the lower portion further comprises an auxiliary power source in electrical communication with the light source.

13. The light fixture of claim 12, wherein the auxiliary power source is one or more batteries.

14. The light fixture of claim 10, wherein the lower portion further comprises a USB port in electrical communication with the one or more rechargeable batteries.

15. The light fixture of claim 10, wherein the lower portion further comprises a motion sensor in electrical communication with the light source and the one or more rechargeable batteries.

16. The light fixture of claim 10, wherein the lower portion further comprises a switch for adjusting the intensity of the light source, the switch being in electrical communication with the light source and the one or more rechargeable batteries.

17. The light fixture of claim 10, wherein the light source includes LED lights.

18. The light fixture of claim 10, wherein the lower portion further comprises:
a. an auxiliary power source in electrical communication with the light source;
b. a USB port in electrical communication with the one or more rechargeable batteries;
c. a motion sensor; and
d. a switch for adjusting the intensity of the light source, the switch and the motion sensor being in electrical communication with the light source and the one or more rechargeable batteries.
